(19) United States
(12) Patent Application Publication
(10) Pub. No.: US 2005/0055285 A1
(43) Pub. Date: Mar. 10, 2005

(54) Method and system for managing exchanges related to freight claims

(76) Inventors: Stephanie Myrick, Austin, TX (US); Diana Wheeler, Austin, TX (US)

Correspondence Address: HAMILTON & TERRILE, LLP, P.O. BOX 203518, AUSTIN, TX, 78720, US

(21) Appl. No.: 10/884,212

(22) Filed: Jul. 2, 2004

Related U.S. Application Data
(63) Continuation-in-part of application No. 10/657,983, filed on Sep. 9, 2003.

(51) Int. Cl. G06F 17/60

(52) U.S. Cl. 705/28

(57) ABSTRACT

Freight claims of a manufacturer to a logistics service provider are automated to manage re-orders of built to order products, such as information handling systems, in response to delivery reports from customers for lost or damaged freight. Upon receipt of a delivery report, a customer interface allows manual initiation of a re-delivery order for another delivery of the product from the manufacturer center to the customer. A freight claim engine automatically initiates communication to the logistics service provider and determines the response of the logistics service provider to the delivery report. A re-delivery validation engine overrides manually initiated re-delivery orders in the event of a first set of predetermined logistics service provider responses, such as acceptance by the customer of the product, and allows re-delivery orders to continue to the manufacturer center in the event of a second set of predetermined logistics service provider responses, such as acceptance of financial responsibility by the logistics service provider for the product due to a failed delivery or damage inflicted during shipment.

### RELATED APPLICATIONS

This application is a continuation-in-part of U.S. Patent Application Ser. No. 10/657,983, filed on Sep. 9, 2003, entitled “Method and System for Automated Freight Claims,” by Stephanie Myrick and Janis James.

### BACKGROUND OF THE INVENTION

1. Field of the Invention

The present invention relates in general to the field of freight delivery, and more particularly to a method and system for managing exchanges related to freight claims for lost or damaged freight.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

The great number of different component types and manufacturers used to configure information handling systems allows businesses and individuals tremendous flexibility in configuring information handling systems to meet desired goals and needs. For instance, a business that uses information handling system primarily for secretarial functions, like word processing, may order large numbers of similarly configured systems that have less expensive processing and video components. By comparison, a researcher who performs intense mathematical computations may order a number of different systems tailored to desired functions like processing computations or displaying detailed graphics. An efficient way of taking and filling orders for information handling systems having different configurations is to build the information handling systems to order. In a build-to-order system, customers order information handling systems with desired hardware and software configurations and the systems are built to the ordered configuration after the order is received. Build-to-order systems provide customers with greater flexibility than is available from inventory-based systems in which customers purchase systems already built to configurations that the manufacturer has selected.

One difficulty with build-to-order systems is that information handling systems built to a customer's desired configuration generally must be shipped to the customer's location after they are complete. Specific tracking of information handling systems during the build process to associate systems with orders often presents a complex task. Once an information handling system is built, a logistics service provider, such as FED EX or UPS, typically picks the system up at the manufacturer's factory and delivers the system to the customer according to instructions provided by the manufacturer. The logistics service provider generally has a specified number of days in which to deliver the information handling system to the customer. Mistakes in manufacture or delivery that preclude delivery of an ordered information handling system to a customer are often not discovered until the customer calls to complain that the information handling system did not arrive as scheduled. Typically, information handling system manufacturers are able to track down internal problems that arise prior to delivery of the completed system to the logistics service provider. However, once an information handling system is handed off to the logistics service provider, the manufacturer generally must depend on the provider to track down delivery failures due to limited exchanges of delivery information through firewalls that protect manufacturer proprietary information and customer privacy. If the lost freight cannot be located and delivered to the customer, a new information handling system is usually built and shipped instead. Typically the communication between the manufacturer and logistics service provider takes time so that replacement systems are often built even though the logistics service provider eventually locates lost freight. The building of replacement systems represents a substantial cost, especially where the original system became lost freight due to an error of the manufacturer, such as an incorrect or mislabeled customer address for delivery. In some instances, replacement systems, know as exchanges, are released to be built even though the logistics service provider has provided proof of delivery. For instance, customer representatives manually intervene to initiate an exchange with incomplete information and before performing a complete investigation about whether the delivery occurred.

### SUMMARY OF THE INVENTION

Therefore a need has arisen for a method and system which automates information handling system manufacturer and logistic service provider lost freight claims.

A further need exists for a method and system which communicates lost freight claims from a shipper to a logistics service provider in an automated and controlled manner.

A further need exists for a method and system which automates cancellation of manufacture or delivery of exchange information handling systems in response to a freight claim where the ordered information handling system was confirmed as delivered by the logistic service provider.

In accordance with the present invention, a method and system are provided which substantially reduce the disadvantages and problems associated with previous methods and systems for freight claim management. A freight claim engine automatically communicates freight claims to a logistics service provider and analyzes responses from the logistics service provider to initiate or preclude re-orders of the product associated with the freight claim.

More specifically, the freight claim engine determines freight claims from customer delivery reports received from customers for delivery of built to order information handling systems. A validation engine validates that the delivery location and associated delivery information matches delivery instructions provided to the logistics service provider. A logistics service provider interface communicates the freight claim to the logistics service provider for a response provided within a predetermined time that is monitored by a response time engine. The freight claims engine receives the response and determines the status of the delivery of the information handling system associated with the freight claim. Lost or damaged deliveries, as determined by the response or failure to respond by the logistics service provider, are re-ordered to have a replacement information handling system sent to the customer. Lost deliveries indicated as found by a timely logistics service provider response are precluded from being re-ordered. An accounting engine tracks freight claims and logistic service provider responses to automatically manage financial responsibility of the logistics service provider for lost or damaged freight claims.

In one embodiment, a customer representative associated with the customer interface initiates a re-delivery order in response to a customer delivery report, such as with a manual selection. Before the re-delivery order is forwarded through the factory interface to manufacture an exchange product, a re-delivery validation engine in communication with the customer interface, freight claim engine and logistics service provider interface determines if the re-delivery order is valid or should be overridden. The re-delivery validation engine overrides manually-input re-delivery orders having one or more of a first predetermined logistics service provider response, such as a response that the product was delivered to the customer or picked up by the customer. The re-delivery validation engine allows the manually-input re-delivery order to proceed to the manufacturer center for manufacture of an exchange product if the logistics service provider responds to the delivery report by accepting financial responsibility for the product, such as where freight is lost or damaged during shipment.

The present invention provides a number of important technical advantages. One example of an important technical advantage is that the freight claims engine automates information handling system manufacturer and logistics service provider lost freight claims. By automatically determining freight claims from customer delivery reports and automatically communicating the freight claims to the logistics service provider, the freight claims engine delays the initiation of builds of replacement information handling systems for a period of time to allow the logistics service provider an opportunity to investigate the status of a delivery. If the logistics service provider determines that delivery will occur in a reasonable time, the manufacturer avoids the cost of an additional information handling system build and improves customer satisfaction with a more rapid delivery.

Another example of an important technical advantage of the present invention is that the freight claims engine communicates lost freight claims from a shipper to a logistics service provider in an automated and controlled manner to improve delivery service for a variety of products. Automated communication of selected customer delivery reports as freight claims improves logistics service provider response times to correct product delivery issues. Where deliveries are built to order products, prompt logistics service provider responses to freight claims provides greater manufacturer efficiencies with an informed decision made in a reasonable time of whether to initiate a re-order of the built to order product or to await delivery of an original misdirected product.

Another example of an important technical advantage is that manually-initiated re-delivery orders are automatically validated based on logistics service provider responses before release for manufacture of an exchange products. Manual interventions made by customer representatives to order exchange systems that are made in error due to incomplete information are automatically cancelled where appropriate, such as where delivery of a product is confirmed by the logistics service provider, thus reducing the unnecessary manufacture and delivery of exchange systems.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 depicts a block diagram of a freight claim management system;

FIG. 2 depicts a flow diagram for freight claim management; and

FIG. 3 depicts a flow diagram of a process for validation of manually-input re-delivery orders.

### DETAILED DESCRIPTION

Automated management of freight claims for built to order information handling systems improves customer satisfaction and reduces manufacturing costs by precluding re-orders for lost information handling system deliveries that are found by a logistics service provider. For purposes of this application, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

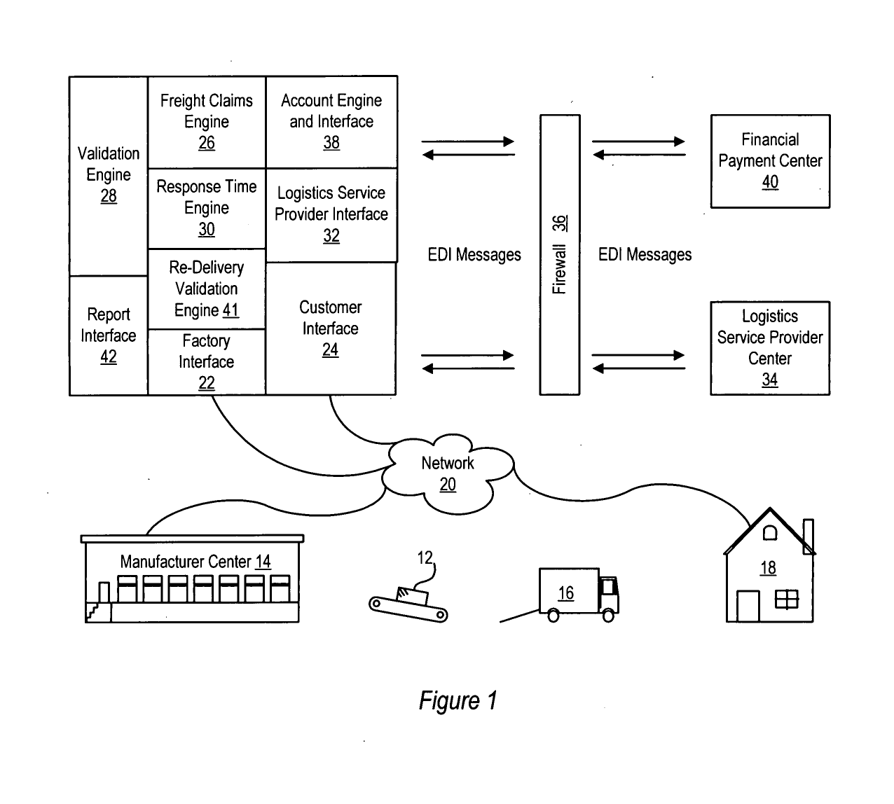

Referring now to FIG. 1, a block diagram depicts a freight claim management system 10 configured to manage freight claims associated with delivery of built to order information handling systems 12. Information handling systems are built in a manufacturer center 14 and shipped by logistics service provider vehicles 16 to a destination location 18, such as a home or business address. The purchase and delivery of information handling system 12 are managed through a network 12, such as by telephone or Internet communications, with the customer of location 18 specifying the configuration and delivery instructions ordered for information handling system 12. Freight management system 12 obtains order and delivery information for built to order information handling systems 12 through a factory interface 22. Customers communicate delivery reports to freight claim management system 10 through a customer interface 24. For instance, delivery reports include delivery of incorrectly configured or damaged information handling systems, and failure to deliver an ordered information handling system in an expected delivery period.

A freight claims engine 26 receives manufacturer center information through factory interface 22 and the customer delivery reports from customer interface 24 to automatically manage freight claims made to the logistics service provider. Freight claims engine 26 may forward all or selected delivery reports to obtain a response from the logistics service provider with the determination of a delivery report as a freight claim based on the urgency of a response and the likelihood of the delivery report involving a logistics service provider error. For instance, a validation engine 28 compares delivery report information with manufacturer center information to identify delivery failures that are likely associated with manufacture errors. Validation engine 28 compares fields populated from the original customer order and fields populated with the delivery report to identify inconsistencies. Examples of fields that are compared or reviewed for validation include product identification information, delivery location information, logistics service provider track information, or shipping date information. As another example, a determination of a delivery report as a freight claim may be based on the likelihood of the resolution of the freight claim with a re-order of the information handling system. If the delivery report, for instance, indicates damage of great severity, then a re-order is a likely resolution and less urgency exists to obtain a response from the logistics service provider.

Freight claims engine 26 reports freight claims to a response time engine 30 for communication to the logistics service provider through a logistics service provider interface 32. Freight claims are communicated by EDI messages to a logistics service provider center 34 with access by the logistics service provider to the information of the information handling system manufacturer restricted by a firewall 36 for security and customer privacy. Logistics service provider 34 performs a trace on the deliveries associated with freight claims to determine the status of the deliveries and reports the status back to freight claims engine 26 through logistics service provider interface 32. Logistics service provider responses approve or deny freight claim financial responsibility. Approved financial responsibility indicates that the delivery was lost or damaged so that freight claim engine 26 may initiate a re-order of the information handling system. Denied financial responsibility requires a denial reason code, proof of delivery, proof of return or projected delivery of the information handling system. Denied financial responsibility indicates that the delivery may still be made and allows freight claims engine 26 to determine based on the denial code whether to initiate a re-order. For instance, proof of delivery with a customer signature may delay a re-order until the claim is investigated for fraud or may result in initiation of a re-order to limit customer delays with actual delivery of the replacement information handling system delayed until the claim is investigated.

Response time engine 30 monitors freight claims and logistics service provider responses to ensure that responses are received in a predetermined time period. Failure to respond to a freight claim by a logistics service provider in the predetermined response time results in an assignment of financial responsibility to the logistics service provider and initiation of a re-order. Freight claims engine 26 provides approved financial claims to an accounting engine and interface 38 which communicates the financial responsibility through EDI messages to a financial payment center 40 responsible for resolving payments between the manufacturer and the logistics service provider. A report interface 42 tracks freight claims to issue status reports for the manufacturer to monitor delivery results. The automated communication of freight claims to the logistics service provider allows for predictable delivery traces without operator intervention so that re-orders of information handling systems may be delayed until a response is received from the logistics service provider without substantial impact on the build time of a replacement information handling system if a replacement becomes necessary. Further, the cost of a re-order may be precluded where the response indicates that the original information handling system has a reasonable likelihood of successful delivery in a predetermined time.

In one embodiment, a customer representative associated with customer interface 24 is allowed to manually-input a re-delivery order in response to a delivery report from a customer even if the delivery report is not yet forwarded to the logistics service provider. Manual intervention allows a customer representative to use business judgment in direct dealings with the customer, such as responding to an upset or particularly valuable customer by immediately initiating a re-delivery order. In order to minimize unnecessary re-delivery orders, a re-delivery validation engine 41 analyzes re-delivery orders before the re-delivery orders are forwarded by factory interface 22 to manufacturer center 14 for manufacture of an exchange system. Re-delivery validation engine 41 applies rules to the information associated with a re-delivery order to determine whether to release a re-delivery order to manufacturer center 14 to build an exchange or to automatically cancel the re-delivery order. For instance, re-delivery validation engine 41 cancels the re-delivery order if the logistic service provider's response to a freight claim associated with the re-delivery order falls within a first set of predetermined responses, such as confirmation that the product was delivered to the customer or picked up by the customer. Delivery or pickup may be confirmed by a variety of factors, such as signature of the customer for the delivery. In contrast, re-delivery validation engine 41 approves the re-delivery order if the logistic service provider's response to a freight claim associated with the re-delivery order falls within a second set of predetermined responses, such as confirmation that the logistics service provider has accepted financial responsibility for a lost or damaged product.

As a specific example, customer interface 24 requires the customer representative to classify based on discussions with the customer each re-delivery order with a reason code of lost, delivered short of a the full order number, denial of signature, delivered to wrong address, left at door, damaged or empty. Re-delivery validation engine 41 compares the entered codes and carrier responses to freight claims to determine whether to cancel or release the re-delivery order. If the customer representative code is that the freight was lost or delivered short, re-delivery validation engine 41 applies the following actions to the list logistic service provider freight claim responses:

TABLE A

| Freight Claim Response | Re-Delivery Validation Engine Action |
|---|---|
| Delivered | Cancel Re-Delivery Order |
| Customer Picked Up | Cancel Re-Delivery Order |
| Returned | Release Re-Delivery Order |
| Mislabeled | Reclass to Delivery Wrong Address and |
| | Resend |

If the customer representative code is that the freight was a denial of signature by the customer, re-delivery validation engine 41 applies the following actions to the list logistic service provider freight claim responses:

TABLE B

| Freight Claim Response | Re-Delivery Validity Cycle Action |
|---|---|
| Delivered and Known Employee | Cancel Re-Delivery Order |
| Customer Picked Up | Cancel Re-Delivery Order |
| Returned | Release Re-Delivery Order |
| Mislabeled | Wrong Address and Resend |

If the customer representative code is that the freight was delivered to the wrong address, re-delivery validation engine 41 applies the following actions to the list logistic service provider freight claim responses:

TABLE C

| Freight Claim Response | Re-Delivery Validation Engine Action |
|---|---|
| Mislabeled | Release Exchange |
| Agreement to Leave Shipment | Cancel Re-Delivery |
| Change Order Action Form | Cancel Re-Delivery |
| Returned | Release Exchange |

If the customer representative code is that the freight was left at the customer door, re-delivery validation engine 41 applies the following actions to the list logistic service provider freight claim responses:

TABLE D

| Freight Claim Response | Re-Delivery Validation Engine Action |
|---|---|
| No Signature Required | Cancel |
| ALS | Cancel |
| Returned | Release |

If the customer representative code is that the freight was damaged and the logistics service provider responds that the damage was concealed damage, re-delivery validation engine 41 releases the re-delivery order. Similarly, if the customer representative code is that the freight was empty and the logistics service provider responds that the shortage was concealed, re-delivery validation engine 41 releases the re-delivery order.

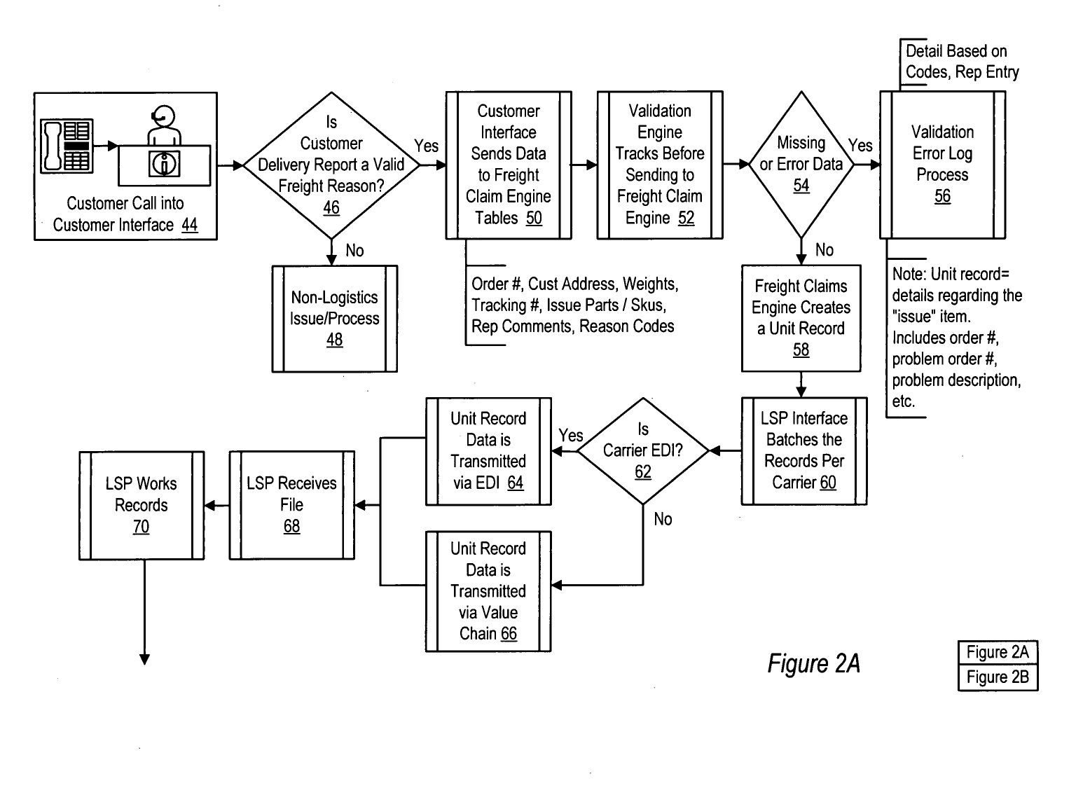

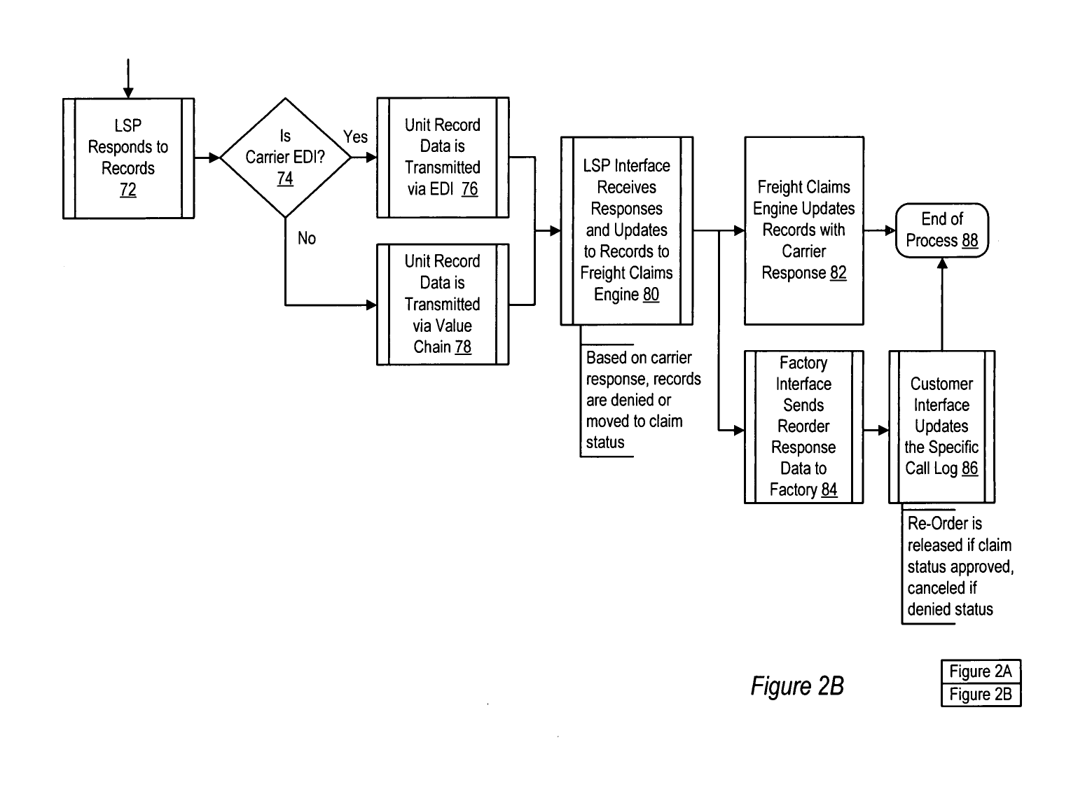

Referring now to FIG. 2, a flow diagram depicts a process for automated freight claims management. The process begins at step 44 with a customer communication of a delivery report to the customer interface, such as by a phone call to a manufacturer customer representative. At step 46 a determination is made of whether the customer delivery report is a valid freight reason. For instance, if the customer call references a missing component in a properly addressed delivery, the delivery report is not considered a freight claim and the process continues to step 48 for handling as a non-logistics issue. If the customer delivery report is determined as a freight claim, such as a failure to deliver an ordered information handling system in an expected time period, the process continues to step 50 for handling as a freight claim with input of delivery report information, such as the order number, customer address, weights, tracking number, SKU or parts number, customer representative comments and reason codes.

At step 52, the validation engine tracks the customer delivery report information for comparison with the original order to information and, at step 54, determines if information is missing or erroneous. If information is missing or erroneous, at step 56 the validation engine logs the error with a red flag for manual handling by a customer care representative. If the information is valid, the process continues to step 58 at which the freight claims engine generates a unit record for the freight claim in a format to allow investigation by the logistics service provider, such as by including the delivery problem, order number and delivery address. At step 60, the logistics service provider interface batches the freight claim for delivery to the logistics service provider. At step 62, a determination is made of whether to communicate the freight claim by EDI message or through a value chain communication medium. If the logistics service provider receives EDI messages, the process continues to step 64 to send the freight claims by EDI message, such as an encrypted EDI 920 file. If the logistics service provider does not receive EDI messages, the process continues to step 66 to send the freight claims by value chain, such as a spreadsheet posted to a secure Web site.

At step 68, the logistics service provider receives and decrypts the freight claim and, at step 70 investigates the status of the information handling system delivery associated with the freight claim. At step 72, the logistics service provide responds to the freight claims with approval of the claim or denial and the associated denial information. If the logistics service provider is determined EDI capable at step 74, the process continues to step 76 at which the response is sent to the manufacturer by EDI message, such as an encrypted 141 file. If the logistics service provider is determined not EDI capable at step 74, the process continues to step 78 at which the response is sent to the manufacturer by a value chain message, such as a spread sheet posted to a secured Web site. At step 80, the logistics service provider interface receives the response and updates the freight claims engine record at step 82 so that the freight claims engine may determine the freight claims status as approved or denied based on the response. At step 84, the factory interface sends responses resulting in re-orders to the factory for building of a replacement information handling system. At step 86, the resolution of the freight claim is provided to the customer interface to update the call log of the customer delivery report and respond to the customer as appropriate. The process completes at step 88 with resolution of the freight claim.

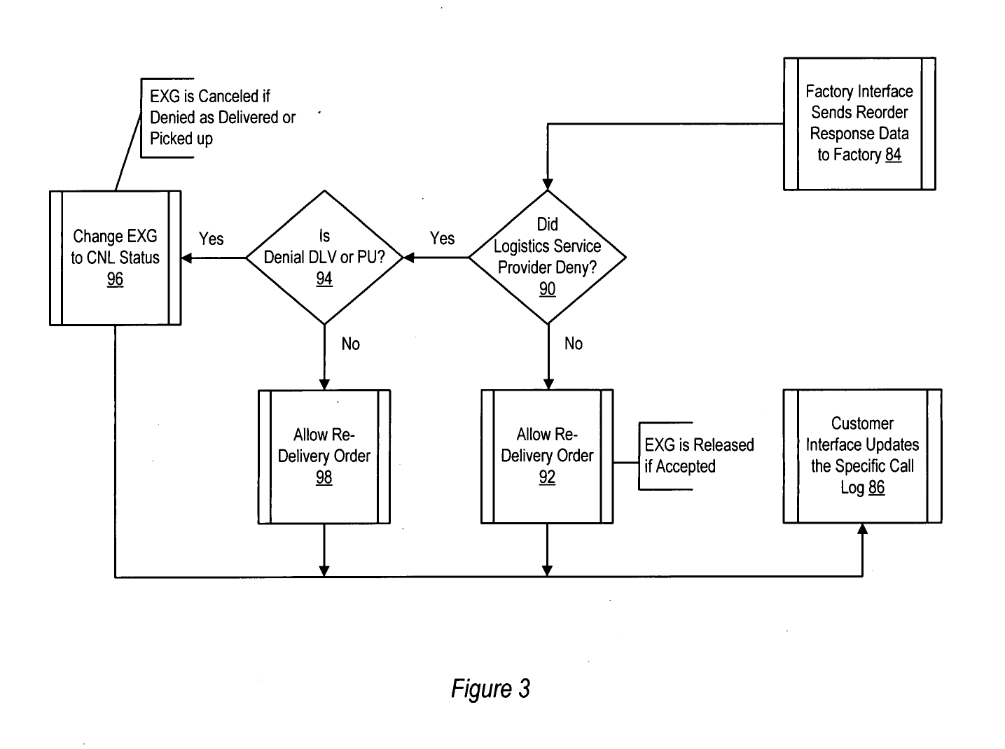

Referring now to FIG. 3, a flow diagram depicts a process for automated validation of manually-input re-delivery orders. At step 84 of FIG. 2, before updating the call log at step 86, the process continues to step 90 of FIG. 3 to determine whether the logistics service provider denied financial responsibility. The process may advance to step 90 for each re-delivery order or selectively for manually-input delivery orders. If the logistics service provider accepted financial responsibility, the process continues to step 92 to release the re-delivery order for manufacture. If the determination at step 92 is that the logistics service provider denied financial responsibility, the process continues to step 94 to determine if the denial is due to a pick up by the customer or delivery to the customer. If the denial is due to acceptance by the customer of the delivery, the process continues to step 96 to change the exchange status of the re-delivery order to a cancelled status. Cancellation of a re-delivery order at step 96 may result in automated fraud investigation or other action to determine the reason for a re-delivery order where a successful delivery occurred. If the determination at step 94 is no, then the process continues to step 98 to release the re-delivery order. In alternative embodiments, the process at step 98 may proceed to more extensive investigation regarding the reason for the re-delivery order or for greater approval within the customer representative authority to release the re-delivery order.

Although the present invention has been described in detail, it should be understood that various changes, substitutions and alterations can be made hereto without departing from the spirit and scope of the invention as defined by the appended claims.

1. A system for automated freight claim management of freight deliveries, the system comprising:
a customer interface operable to accept delivery reports from customers and to accept re-delivery orders manually input by a customer representative;
a freight claim engine operable to automatically process the delivery reports to identify freight claims;
a logistics service provider interface operable to communicate freight claims to the logistics service provider and to receive one or more logistics service provider responses for each freight claim; and
a re-delivery validation engine in communication with the customer interface, freight claim engine and logistics service provider interface, the re-delivery validation engine operable to override manually-input re-delivery orders having a predetermined logistics service provider response.

2. The system of claim I wherein the re-delivery validation engine is further operable to forward re-delivery orders having a predetermined logistics service provider response to a factory interface for manufacture of the re-delivery order.

3. The system of claim 2 wherein the predetermined logistics service provider response to override a delivery order comprises a response that the customer signed for the freight.

4. The system of claim 2 wherein the predetermined logistics service provider response to override a delivery order comprises a response that the customer picked-up the freight.

5. The system of claim 2 wherein the predetermined logistics service provider response to forward re-delivery orders to the factory interface comprises agreement by the logistics service provider to accept financial responsibility for the freight.

6. The system of claim 5 wherein the predetermined logistics service provider response to override a delivery order comprises a customer signature accepting delivery of the freight.

7. The system of claim 1 wherein the deliveries comprise built to order products.

8. The system of claim 7 wherein the built to order products comprise information handling systems.

9. The system of claim 8 further comprising an information handling system order validation engine associated with the freight claims engine and operable to identify and intercept deficient freight claims from communication to the logistics service provider.

10. The system of claim 9 wherein the freight claims engine automatically generates re-delivery orders for deficient freight claims.

11. A method for automated freight claims management of freight deliveries, the method comprising:
receiving delivery reports from customers;
manually initiating a re-delivery order for one or more of the delivery reports;
identifying delivery reports as freight claims by one or more predetermined factors;
automatically communicating freight claims to a logistics service provider associated with the freight deliveries;
receiving responses to the freight claims from the logistics service provider; and
automatically overriding manually-initiated re-delivery orders having one or more predetermined logistics service provider response.

12. The method of claim 11 wherein the deliveries comprise information handling systems.

13. The method of claim 12 wherein automatically resolving the freight claims further comprises:
automatically analyzing the logistics service provider response to determine that the information handling system was delivered to the customer; and
automatically precluding re-delivery of an information handling system to the customer.

14. The method of claim 13 further comprising:
automatically initiating a freight claims fraud investigation.

15. The method of claim 13 further comprising:
validating freight claim information before sending freight claims to the logistics service provider; and
allowing manually-initiated re-delivery of information handling systems associated with an invalid freight claim.

16. The method of claim 13 further comprising:
automatically analyzing the logistics service provider response to determine that the logistics service provide has accepted financial responsibility for failure to deliver the information handling system to the customer; and
allowing the manually-initiated re-delivery of the information handling system.

17. The method of claim 16 wherein communicating freight claims further comprises sending EDI messages.

18. A method for manufacturer management of freight claims associated with delivery of build to order products by a logistics service provider, the method comprising:
accepting orders from plural customers for products to be built to a customer-ordered configuration;
building the products;
providing the products to a logistics service provider for delivery of each product to a location associated with a customer;
receiving delivery reports from one or more customers, each delivery report associated with a product delivery by the logistics service provider;
manually initiating a re-delivery of a product in response to a delivery report;
automatically communicating the delivery report to the logistics service provider;
receiving a response of the logistics service provider to the delivery report; and
automatically overriding re-delivery of the product in the event of a first set of predetermined logistics service provider responses; and
automatically allowing re-delivery of the product in the event of a second set of predetermined logistics service provider responses.

19. The method of claim 18 wherein the first set of predetermined logistics service provider responses comprise a response indicating acceptance of the product by the customer.

20. The method of claim 19 wherein the products comprise information handling systems.
